(19) United States
(12) Patent Application Publication
(10) Pub. No.: US 2009/0288648 A1
(43) Pub. Date: Nov. 26, 2009

(54) SUPERCHARGERS WITH DUAL INTEGRAL ROTORS

(75) Inventors: Gregory P. Prior, Birmingham, MI (US); Roxann M. Bittner, Royal Oak, MI (US)

Correspondence Address: GENERAL MOTORS COMPANY;LEGAL STAFF, MAIL CODE 482-C23-B21, P O BOX 300, DETROIT, MI, 48265-3000, US

(73) Assignee: GM GLOBAL TECHNOLOGY OPERATIONS, INC., DETROIT, MI (US)

(21) Appl. No.: 12/124,280

(22) Filed: May 21, 2008

(51) Int. Cl. F02B 33/00

(52) U.S. Cl. 123/559.1

(57) ABSTRACT

In an exemplary embodiment, a dual rotor supercharger includes a pair of rotor housings. Each housing has an air inlet end and an air outlet adjacent a drive end. Each rotor housing contains a pair of coacting rotors with a pair of engaged timing gears operative to rotate the rotors on parallel axes in their housings to pump air from the inlet ends to the outlets of their respective housings. A drive housing encloses the two pairs of timing gears connected within the drive housing for simultaneously rotating the rotors in each rotor housing for delivering air through the outlets of their respective housings. At least one drive member is directly connected with one of the rotors and operative to rotate all of the rotors through the connected timing gears. Various alternative embodiments of the superchargers and operating mechanisms are disclosed.

### TECHNICAL FIELD

This invention relates to positive displacement air pumps or superchargers, such as roots type blowers or screw compressors utilized for automotive engine superchargers and other purposes.

### BACKGROUND OF THE INVENTION

It is known in the art to utilize superchargers for supercharging internal combustion engines and for providing compressed air for other purposes. However, supercharger packaging within an automotive engine compartment is affected by the length and diameter of the rotors. Rotor length relative to diameter (L/D) is limited due to pressure deflection and natural frequencies. As L/D increases, rotor deflections can lead to scuff. This limits the maximum production length for a given diameter rotor family.

L/D limitations can result in difficulty packaging rotors for optimum performance. For inline engines, superchargers are typically placed alongside the engine. For V type engines, superchargers are typically located between the heads. With either type of engine, it can be difficult to package the optimal size supercharger unit due to L/D constraints.

### SUMMARY OF THE INVENTION

The present invention provides a solution for some difficult application problems. By combining two smaller supercharger units into a single device, the effective L/D of a given supercharger displacement is safely made much greater. The combined units can be arranged end to end or diagonally depending on desired packaging. Side by side units can be combined with an idler gear into a single unit as well. Such units can be coplaner or arranged in a V or U profile as well.

Many internal components could be common to single supercharger systems of the same rotor family, so the cost for a larger displacement would be less than for tooling up an all new larger diameter family. Advantages of these dual rotor units include simplified mounting and drive provisions, and increased stiffness versus separate units of equivalent size.

In an exemplary embodiment, a dual rotor supercharger includes a pair of rotor housings each having an air inlet end and an air outlet adjacent a drive end, each rotor housing containing a pair of rotors with a pair of engaged timing gears operative to rotate the rotors on parallel axes in their housings to pump air from the inlet ends to the outlets of their respective housings; a drive housing enclosing the two pairs of timing gears, the timing gears being connected within the drive housing for simultaneously rotating the rotors in each rotor housing for delivering air through the outlets of their respective housings; and at least one drive member directly connected with one of the rotors and operative to rotate all of the rotors through the connected timing gears.

These and other features and advantages of the invention will be more fully understood from the following detailed description of exemplary embodiments taken together with the accompanying drawings.

### DESCRIPTION OF THE DRAWINGS

FIG. 1 is a pictorial external view of a common centerline dual supercharger unit according to the invention;

FIG. 2 is a pictorial internal view of the dual unit of FIG. 1;

FIG. 3 is an external view similar to FIG. 1 of an offset centerline dual supercharger unit;

FIG. 4 is an internal view similar to FIG. 2 of the offset centerline unit of FIG. 3;

FIG. 5 is an external view similar to FIG. 3 of a side by side dual supercharger unit; and

FIG. 6 is an internal view similar to FIG. 4 of the side by side dual supercharger unit of FIG. 5.

### DESCRIPTION OF AN EXEMPLARY EMBODIMENT

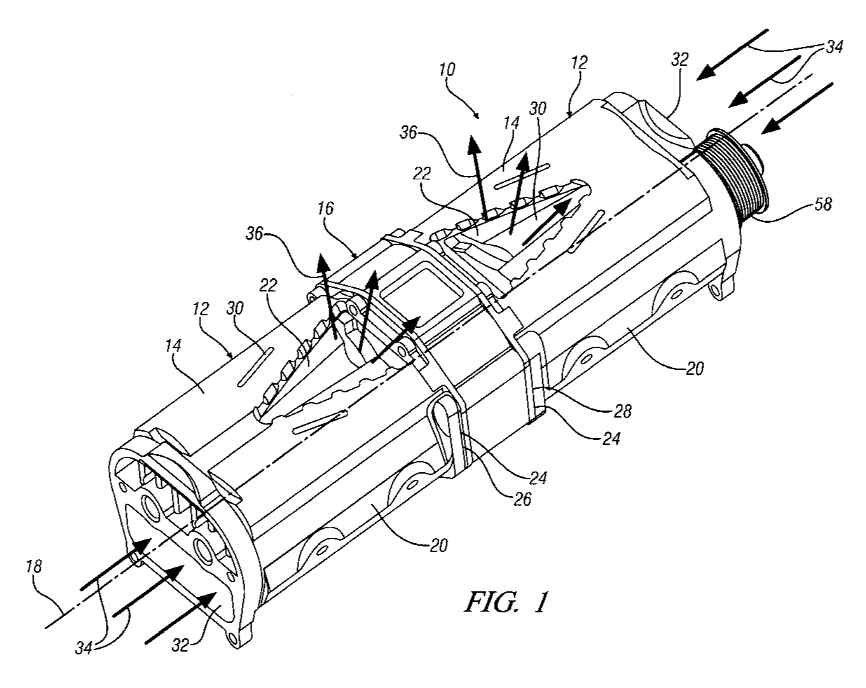

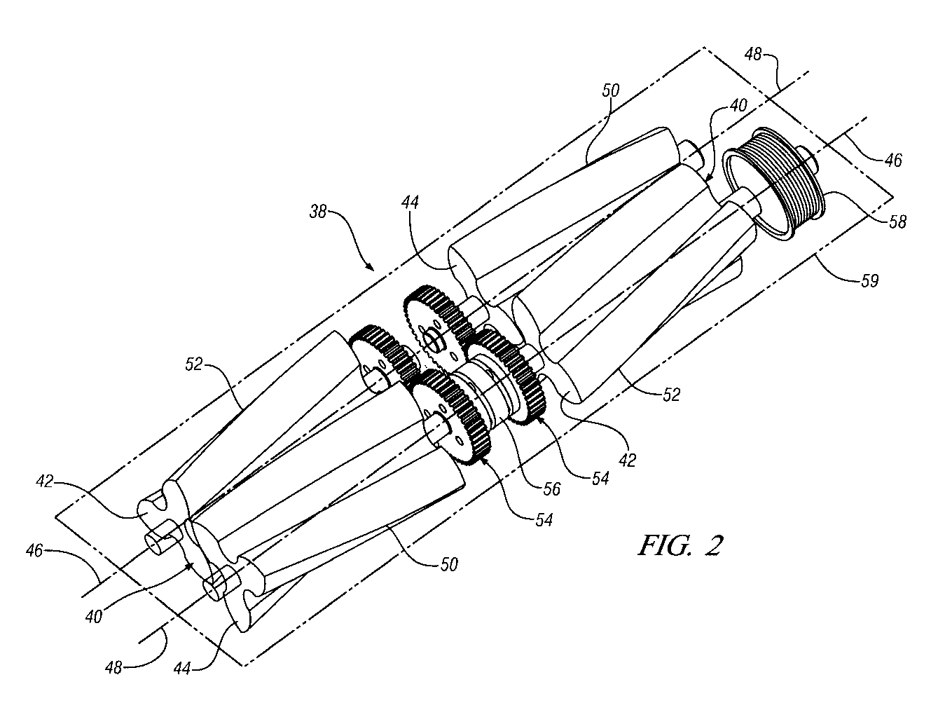

Referring first to FIGS. 1 and 2 of the drawings in detail, numeral 10 generally indicates a first exemplary embodiment of a dual supercharger unit. As shown in the example of FIG. 1, unit 10 comprises two similar supercharger assemblies 12 having rotor housings 14 extending oppositely from a common drive housing 16 and aligned on a common longitudinal centerline 18.

The rotor housings 14 have peripheral walls 20 enclosing rotor cavities 22 and mounting flanges 24 connected to opposite ends 26, 28 of the drive housing 16. Each rotor cavity has an air outlet 30 through its peripheral wall 20 adjacent its mounting flange 24. Inlet air to each rotor cavity 22 is admitted through an inlet end 32 of each rotor housing distal from its mounting flange 24. Inlet air flow to the rotor housings is indicated by arrows 34 while outlet air flow is indicated by arrows 36.

FIG. 2 illustrates exemplary operating mechanisms 38 carried within the rotor and drive housings 14, 16. Mechanisms 38 include rotor sets 40. Examples of the rotor sets 40 may include, but are not limited to, those for positive displacement superchargers of a known roots type. Each roots type rotor set has dual rotors 42, 44 rotatable on parallel axes 46, 48. The roots type rotors have, respectively, left hand and right hand twist helical lobes 50, 52, shown interleaved in their use positions in the rotor housings 14. It should be understood that any other type of rotor set 40, such as screw type rotor sets (not shown), may be applicable to the present invention.

The rotors of each set 40 are connected with engaged timing gear sets 54 rotatable with their connected rotors. A coupling 56 between one gear of each gear set on coaxial axes 46, 48 drives both gear sets 54 and the connected rotor sets 40 for simultaneous rotation and combined air delivery from both. A drive pulley 58 mounted on the distal end of the rotor 42 on axis 46 drives both supercharger assemblies. Note that the axes of the left and right hand twist rotors 42, 44 of both rotor sets 40 lie in a common plane 59.

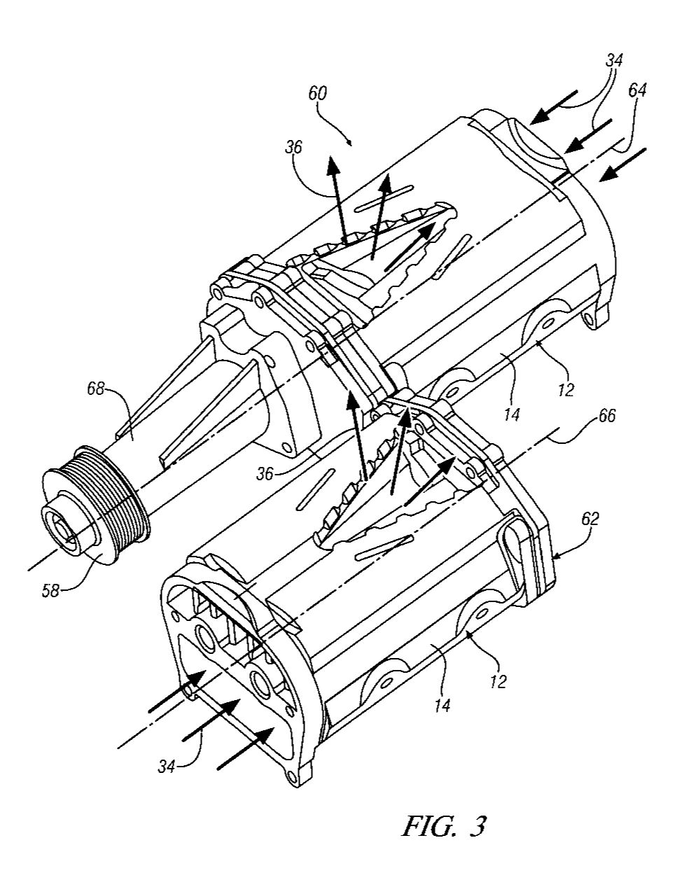

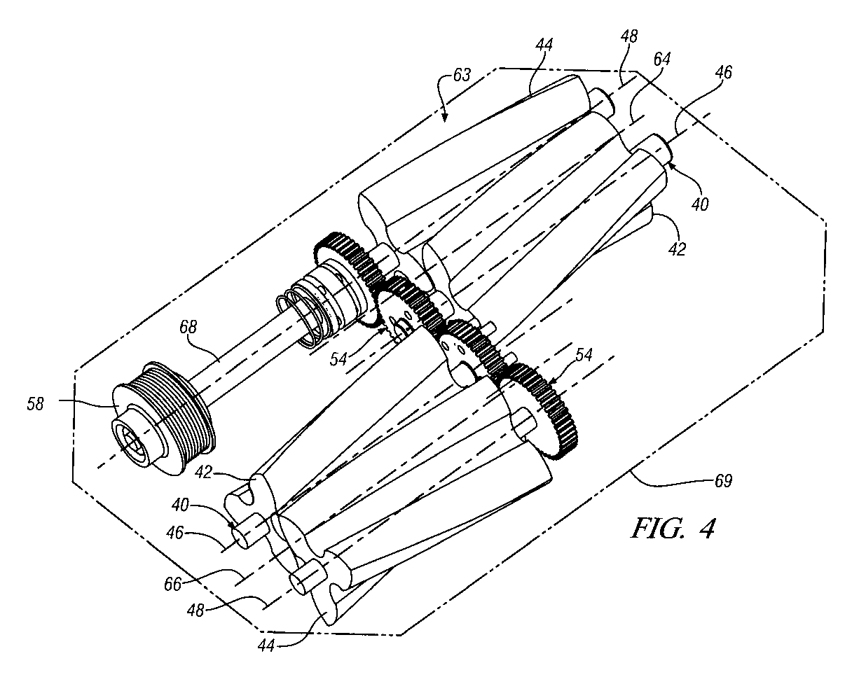

Referring to FIGS. 3 and 4 of the drawings, numeral 60 generally indicates a second exemplary embodiment of a dual supercharger unit wherein like reference numerals continue to indicate like parts. Unit 60 comprises two similar supercharger assemblies 12 having rotor housings 14 extending oppositely from a common drive housing 62. However, the assemblies 12 and the operating mechanisms 63 are arranged in an alternative configuration.

The components of the superchargers 12 are identical to those of the first supercharger unit 10, however, parallel centerlines 64, 66 of the supercharger assemblies 12 are laterally displaced so that the assemblies 12 are diagonally displaced. Further, the timing gear sets 54 are laterally aligned and engaged so that the rotor sets 40 are driven simultaneously without the use of a separate coupling. The drive housing 62 is extended to cover the aligned gear sets. A drive pulley 58 connects through a driveline 68 with an outer rotor of one of the rotor sets 40 and the driveline is mounted on the drive housing 62. Again, the axes 46, 48 of the left and right hand twist rotors 42, 44 of both rotor sets 40 lie in a common plane 69.

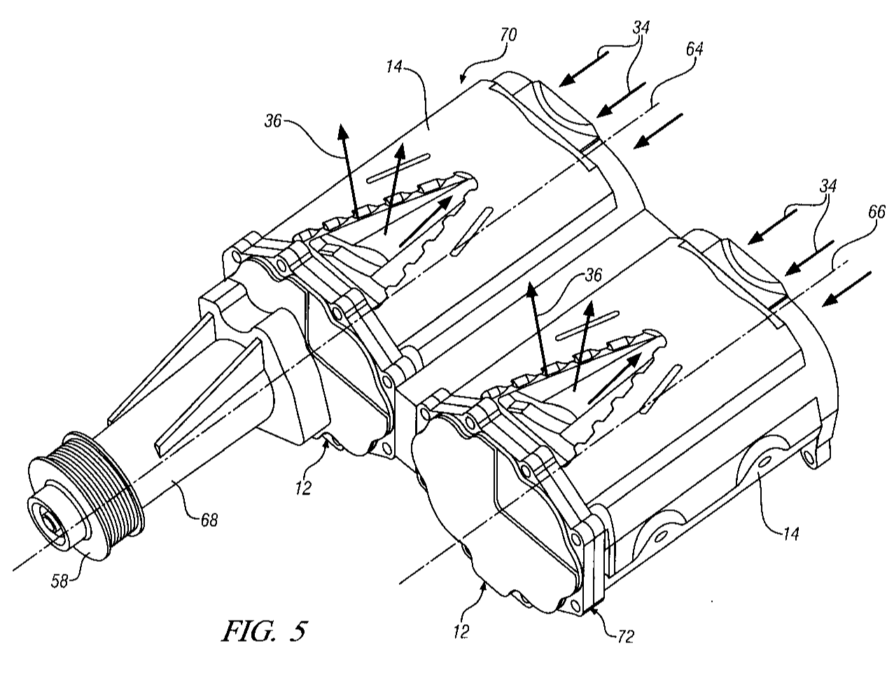

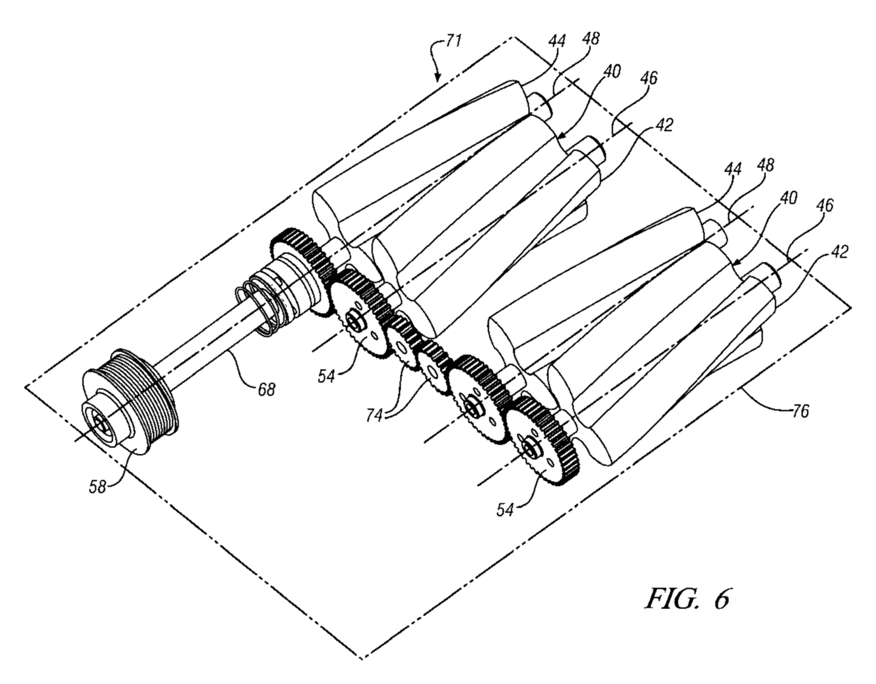

Referring to FIGS. 5 and 6 of the drawings, numeral 70 generally indicates a third exemplary embodiment of a dual supercharger unit wherein like reference numerals indicate like parts among all three embodiments. Unit 70 also includes two similar supercharger assemblies 12 having rotor housings 14. However, the assemblies 12 and the operating mechanisms 71 again have alternative configurations so that the rotor housings 12 lie side by side and extend longitudinally on parallel centerlines 64, 66 from the same end of the drive housing 72. The timing gear sets 54 are aligned laterally as in the second embodiment 60 but are connected by idler gears 74 for proper rotation and spacing. The drive pulley 58 connects through a driveline 68 with an outer rotor of one of the rotor sets 40 and the driveline is mounted on the drive housing 72.

Again, the axes 46, 48 of all the rotors 42, 44 lie in a common plane 76. It is noted that in all three embodiments so far described, the axes of all the rotors lie in a common plane. However, the third embodiment 70 could be modified to have other configurations, such as V or U arrangements where the rotor sets 40 of the two supercharger assemblies 12 are not coplanar.

Each of the illustrated embodiments, as well as others which have been mentioned or may be contemplated, has the common advantage of using dual rotor sets of shorter length and displacement to substitute for longer single rotor sets of equal total displacement to provide stiffer rotors with closer clearances and improved avoidance of scuffing. Further, the use of multiple units provides opportunities for improved packaging that may assist in mounting of supercharged engines in engine compartments of limited or unusual size or configuration.

While the invention has been described by reference to certain preferred embodiments, it should be understood that numerous changes could be made within the spirit and scope of the inventive concepts described. Accordingly, it is intended that the invention not be limited to the disclosed embodiments, but that it have the full scope permitted by the language of the following claims.

1. A dual rotor supercharger comprising:
a pair of rotor housings each having an air inlet end and an air outlet adjacent a drive end, each rotor housing containing a pair of coacting rotors with a pair of engaged timing gears operative to rotate the rotors on parallel axes in their housings to pump air from the inlet ends to the outlets of their respective housings;
a drive housing enclosing the two pairs of timing gears, the timing gears being connected within the drive housing for simultaneously rotating the rotors in each rotor housing for delivering air through the outlets of their respective housings; and
at least one drive member directly connected with one of the rotors and operative to rotate all of the rotors through the connected timing gears.

2. A supercharger as in claim 1 wherein the rotor housings are connected in axial alignment to opposite ends of the drive housing, the two pairs of rotors rotate on coaxial axes and the pairs of timing gears are connected by a coupling between a pair of coaxial timing gears in the drive housing.

3. A supercharger as in claim 2 wherein the drive member is coaxial with the coupling.

4. A supercharger as in claim 1 wherein the rotor housings are diagonally offset with their drive ends connected to opposite ends of the drive housing and the two pairs of timing gears are directly engaged and laterally aligned within the drive housing.

5. A supercharger as in claim 4 wherein the drive member is connected directly with one of the timing gears within the drive housing and the axes of the rotors all lie in a common plane.

6. A supercharger as in claim 1 wherein the rotor housings lie side by side with their drive ends connected to the same end of the drive housing and the two pairs of timing gears are connected by idler gears engaging adjacent timing gears of the two pairs.

7. A supercharger as in claim 6 wherein the axes of the rotors all lie in a common plane and the drive member is connected directly with one of the timing gears within the drive housing.

8. A supercharger as in claim 1 wherein the axes of the rotors all lie in a common plane.
